(19) United States
(12) Patent Application Publication
(10) Pub. No.: US 2008/0097966 A1
(43) Pub. Date: Apr. 24, 2008

(54) Apparatus and Method for Providing Regional Information Based on Location

(75) Inventors: Jin Wan Choi, Kyunggi-do (KR); Young-hoon Jun, Kyunggi-do (KR)

Correspondence Address: Law Office of Mark J. Spolyar, 38 Fountain Street, San Francisco, CA, 94114, US

(73) Assignee: Yahoo! Inc. a Delaware Corporation

(21) Appl. No.: 11/608,501

(22) Filed: Dec. 8, 2006

(30) Foreign Application Priority Data
Oct. 18, 2006 (KR) 10-2006-101254

(51) Int. Cl. G06F 17/30

(52) U.S. Cl. 707/3

(57) ABSTRACT

A method and system for providing regional information based on location is disclosed. In accordance with the present invention, a user inputs a keyword, from which a target location and a search category are extracted. A location range for search is determined by setting a center of the location range to the target location. Search result data are retrieved from a search information database based on the search category and the location range. The location range may be increased or decreased in response to a user's request, based on which the search result data are updated. The apparatus and method of the present invention provides search results ranked within a certain geographical range from a target location, which makes it possible for a specific location-based business to advertise through an Internet search service in a cost-effective way.

### TECHNICAL FIELD

The present disclosure generally relates to a search engine and information system.

### BACKGROUND

Nowadays, as an Internet search engine is becoming a powerful tool for searching information distributed all over the world, many people search the regional information related to their residence or workplace via the Internet. However, the amount of search results provided through the Internet is so huge that it becomes very difficult for a user to find out the regional information that he/she really needs among the search results.

FIG. 12 shows a screen-shot displaying a keyword input window and search results obtained in accordance with a conventional search technology. As illustrated in FIG. 12, the conventional Internet search engine searches target information without taking into account location information included in a keyword. For example, if keywords “tasty restaurant” are inputted to the Internet search engine, web links to information on various restaurants would be presented to a user without listing relevant regional information. Accordingly, since the target information is not properly ranked in the search results based on the user-specified region or location, e.g., if a user is looking for a restaurant around a specific subway station, the user has to click each web link in the search results and check whether it includes the relevant regional information.

For example, if the keywords, “tasty restaurant<AND>Gangnam subway station” is inputted in an Internet search engine to locate a restaurant around a specific region, i.e., Gangnam subway station, then a plurality of search results related to the keywords “tasty restaurant” and “Gangnam subway station” are presented to the user. However, the search results are displayed in a randomly ordered fashion, which includes web links to information on tasty restaurants irrelevant to the specific region as well as information on the specific region irrelevant to the tasty restaurants.

Meanwhile, if a sponsor of an advertisement listed in the search results is a business based on a specific region, they may want their advertisement displayed at a higher rank in the search results based on the specific region. However, since the conventional search engine does not incorporate location information into the search results, the specific region-based sponsor has to compete with the other sponsors based on a country-wide or world-wide region and therefore pay more advertisement fees than expected in order to be ranked higher in the searched results. This makes it difficult for a specific region-based business to advertise their product or store in the Internet in a cost-effective way.

### SUMMARY

In accordance with one embodiment of the present invention, there is provided a method for providing regional information, responsive to a search query, based on location. In the method, a keyword is received from a user, and location information and a search category are extracted from the keyword. Then, search result data are retrieved based on the search category and the location information. The search result data are transmitted to the user, and the search result data and the search category are stored temporarily. A feature of particular embodiments of the present invention is to provide an apparatus and method for providing regional information based on location, in which location information is extracted from an inputted keyword, and search result data are retrieved within a location range which is determined based on the location information. Another feature of particular embodiments is to provide an apparatus and method for providing regional information based on location, in which the location range is updated based on a search radius inputted from a user, updating the search result data based on the updated location range.

In accordance with another embodiment of the present invention, an apparatus for providing regional information based on location includes a keyword receiver for receiving a keyword from a user, a text search engine for extracting location information and a search category from the received keyword, a location search engine for retrieving search result data based on the search category and the location information, a search result data transmitter for transmitting the search result data to the user, and a temporary storage for storing the search category and the search result data.

In one embodiment, search result data may be retrieved based on a predetermined location range, the center of which is set by a location indicated. In this case, a search radius may be received from the user. Then, an updated location range is determined based on the location information and the received search radius, and updated search result data is retrieved based on the search category and the updated location range.

### BRIEF DESCRIPTION OF THE DRAWINGS

FIG. 1 shows a configuration of a network system including an apparatus for providing regional information based on location in accordance with one embodiment of the present invention.

FIG. 2 shows a configuration of an apparatus for providing regional information based on location in accordance with one embodiment of the present invention.

FIG. 3 shows an example of a graphic user interface for receiving a keyword from a user.

FIG. 4 shows a detailed configuration of a text search engine included in an apparatus for providing regional information based on location in accordance with one embodiment of the present invention.

FIG. 5 shows a detailed configuration of a location search engine included in an apparatus for providing regional information based on location in accordance with one embodiment of the present invention.

FIG. 6 shows an example of a graphic user interface for presenting search result data to a user in accordance with one embodiment of the present invention.

FIG. 7 shows an example of a graphic user interface for presenting to a user updated search result data based on an updated search radius in accordance with one embodiment of the present invention.

FIG. 8 shows a flow chart of a method for providing regional information based on location in accordance with one embodiment of the present invention.

FIG. 9 shows a flow chart of a process for updating searched results in response to a received radius in accordance with one embodiment of the present invention.

FIG. 10 shows a flow chart of another embodiment of the step for retrieving updated search result data.

FIG. 11 shows an example computing system architecture, which may be used to implement a server for providing regional information based on location in accordance with one embodiment of the present invention.

FIG. 12 shows a screen-shot displaying a keyword input window and search results retrieved in accordance with a conventional search technology.

### DESCRIPTION OF EXAMPLE EMBODIMENTS

Example embodiments of the present invention will be described in detail below with reference to the accompanying drawings. It will be apparent, however, that these embodiments may be practiced without some or all of these specific details. In other instances, well known process steps or elements have not been described in detail in order not to unnecessarily obscure the description of example embodiments of the invention.

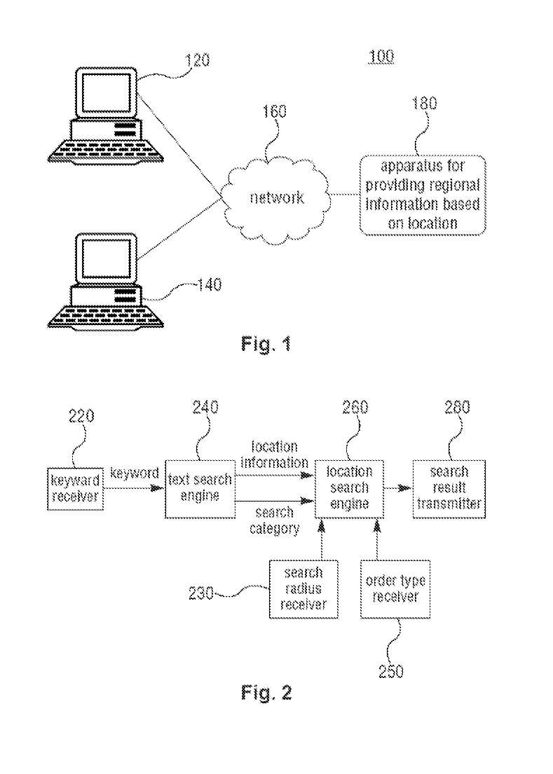

FIG. 1 shows a configuration of a network system including an apparatus for providing regional information based on location in accordance with one embodiment of the present invention. The network system 100 includes a plurality of user terminals 120 and 140, a network 160 and an apparatus 180 for providing regional information based on location. The user terminals 120 and 140 may include a desktop computer, a personal digital assistant (PDA), a mobile phone or any type of terminals connectable to the network 160. The network 160 may include, for example, a wired network such as Internet or LAN or a wireless network such as WiBro, WiFi and BlueTooth technologies. The apparatus 180 is connected to the network 160. The user terminals, 120 and 140 are connected to the network 160, through which the user terminals 120 and 140 send a request for searching target information and receive search results to/from the apparatus 180. In the following, a detailed configuration of the apparatus 180 will be described with reference to FIGS. 2 to 5.

FIG. 2 shows a block diagram of an apparatus for providing regional information based on location in accordance with one embodiment of the present invention. As shown in FIG. 2, the apparatus 200 for providing regional information based on location includes a keyword receiver 220, a text search engine 240, a location search engine 260 and a search result transmitter 280. The keyword receiver 220 and the search result transmitter 280 of the apparatus 200 are connected to a network to receive a keyword from a user and to transmit search results to the user. In one embodiment, the apparatus 200 further include a search radius receiver 230 and an order type receiver 250 connected to the network.

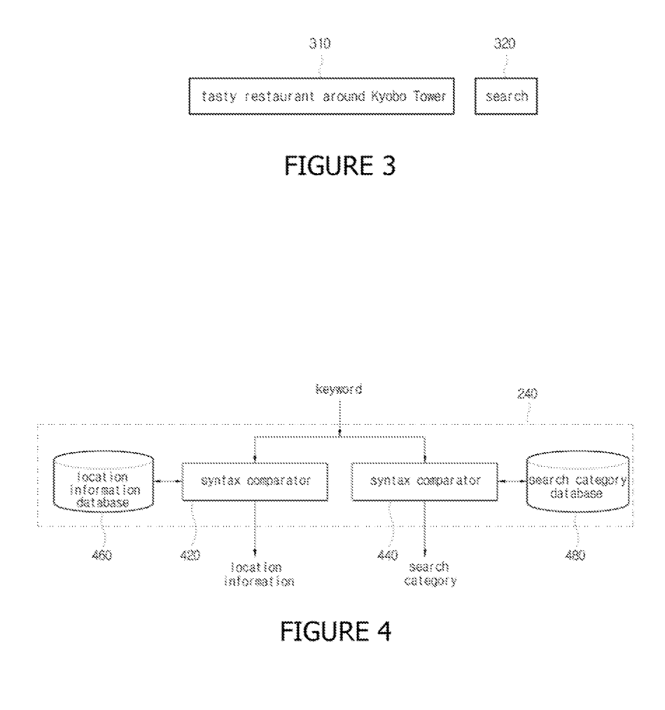

The keyword receiver 220 receives a keyword from a user via the network and transfers the received keyword to the text search engine 240. FIG. 3 shows an example of a graphic user interface, through which the keyword receiver 220 receives a keyword from a user. As illustrated in FIG. 3, a user may input keywords into an input window 310 and click a search button 320 to transmit the keywords to the keyword receiver 220 of the apparatus 200. For example, the inputted keywords include a phrase (“Kyobo Tower”) related to location information such as a building name an another phrase (“tasty restaurant”) related to a search category such as a certain type of shop.

Then, the text search engine 240 extracts location information and a search category from the received keywords and transfer them to the location search engine 260. FIG. 4 shows a detailed configuration of the text search engine 240. As illustrated in FIG. 4, the text search engine 240 includes two syntax comparators 420 and 440, a location information database 460 and a search category database 480.

The syntax comparator 420 extracts text (e.g., “Kyobo Tower”) related to location information from the received keyword, by referring to the location information database 460. Then the syntax comparator 420 transfers the location information indicated by the extracted text to the location search engine 260. The syntax comparator 420 may employ any well-known syntax analysis algorithm, and a detailed description thereof is omitted.

The location information database 460 stores a plurality of template keywords and location information related thereto. The template keywords stored in the location information database 460 may include, for example, names of districts such as “Seoul,” “Jongno-Gu,” and “Anguk-Dong” etc., names of trail or subway stations such as “Chuncheon station” and “Yeodo station”, or names of schools or government offices such as “Incheon Elementary School” or “Jongno-Gu district office.” Further, the template keywords related to location information may include idioms representing a well-known region such as “Gangnam,” “Bundang,” and “Apgujeong,” building names such as “Kyobo Tower” and “Heungkuk Insuarnace Building,” or crossroad names such as “Kwanghwamun Crossroads” and “City hall Crossroads.” The location information database 460 stores location information related to the template keywords such as 2-dimensional coordinates of geographic locations represented by the keywords on a map.

Meanwhile, the syntax comparator 440 extracts a text related to a search category from the received keywords, by referring to the search category database 480 and transfers the search category indicated by the extracted text to the location search engine 260. For example, “tasty restaurant” included in the inputted keywords as shown in FIG. 3 can be mapped to a search category “restaurant” in the search category database 480. In a similar way, if the keyword includes “Chinese food,” this may be mapped to a search category “Chinese restaurant” in the search category database 480. Also, the syntax comparator 440 may employ any well-known syntax analysis algorithm, and a detailed description thereof is omitted.

The search category database 480 includes any type of categories, which users are expected to search for. The categories may, not limited to but, include a convenience facility such as a restaurant, a shopping center, a convenience store and a beauty shop, an educational institute, a hospital, a library, a subway station, a government office, an accommodation such as a hotel, an entertainment facility such as a theme park, etc.

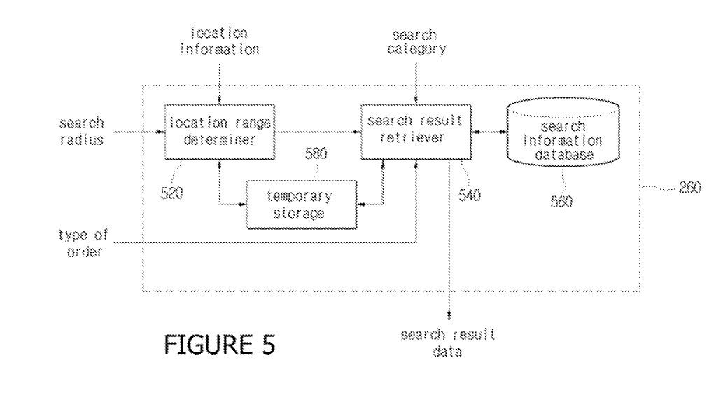

Returning to FIG. 2, the location search engine 260 received the location information and the search category from the text search engine 240, retrieves search results data (e.g., web links to relevant information based on the location information and the search category, and transfers the search result data to the search result transmitter 280. FIG. 5 shows a detailed configuration of the location search engine 260. As illustrated in FIG. 5, the location search engine 260 includes a location range determiner 520, a search result retriever 540 and a search information database 560. In one embodiment, the location search engine 260 further includes a temporary storage 580.

The location range determiner 520 calculates a 2-dimensional location range based on the location information received form the text search engine 240 and transfers the calculated location range to the search result retriever 540. For example, the 2-dimensional location range may be an internal area of a regular square, a center of which is set to a location represented by the location information. Also, the location range may be determined using one of any other shapes such as a circle, a triangle, a polygon, etc. The size of the location range can be defined as a distance (or referred to as a search radius) from the location indicated by the location information. A default size of the location range is set to, e.g., 500 m, but is not limited thereto. Alternatively, the default size of the location range may depend on the location indicated by the location information. In one particular implementation, a default location range value is associated with each location entry in a database. For example, the default size of the location range in a city may be lower than that in a small town. Further, the size of the location range may be selected by a user, e.g., from a list of sample sizes in a list box displayed on a screen.

The search result retriever 540 retrieves search result data in the search information database 560 based on the location range determined by the location range determiner 520, and the search category determined by the text search engine 240. In one embodiment, the search result retriever 540 calculates a distance between a location relevant to each of the search result data and a center of the location range. The search result data may be arranged in the order of the distance from the center of the location range. As such, in accordance with the embodiment, more customized search results can be provided to a user by taking into account both search categories and relevant location information.

The search information database 560 stores the search result data retrieved by the search result retriever 540. The search result data are stored with relevant geographical coordinates in the search information database 560, based on which the search result data may be classified into a plurality of search categories. For example, the search result data retrieved based on a keyword including a name of a Chinese restaurant is classified into a search category such as “foods/groceries>restaurant>Chinese restaurant”. Further, the addresses of the restaurants included in the search result data are converted to geographical coordinate on a 2-dimensional map. The search result data stored in the search information database 560 may also include other information such as contact information, the number of available seats, credit card usability or any other information that the stores or places related to the search result data provides. The search information database 560 may further include evaluation information provided by users who had visited the places related to the search result data.

The search information database 560 may store advertisements, which are related to the stores or places represented by the search result data. The advertisements may be prioritized among those for stores or places within the location range, e.g., based on advertisement fees paid by its sponsors. As such, the sponsors of the advertisements would compete for a higher rank in the search results with those who have their stores within the location range, thereby reducing the costs for advertisements, when compared to the case where the advertisements are ranked regardless of its relevant geographical locations. As such, advertisement markets through the Internet search services can be enhanced.

Also, by employing the apparatus of the invention, web search service providers have advantages that advertisement markets can be enlarged through prioritizing advertisements for web links to information on stores or places within a certain geographical range. For example, assume that the number of the search results to be presented for a user is limited If a search for a certain type of a store is performed without considering its relevance to geographical location, and advertisement sponsor for the store would have to compete with other sponsors having their stores around the whole regions of a country or all over the world. Such competition among the sponsors having their stores over a hugh geographical area would increase their advertisement costs, so that businesses based on specific regions cannot afford to pay for the costs. Thus, specific region-based businesses would hesitate to sponsor their advertisements in a list of search results, which leads to a reduction of potential sponsors for advertisements in an Internet search service. Whereas, if a search is performed based on a certain geographical range, competition among advertisement sponsors is limited to such a geographical range, such that the advertisement costs are kept in a reasonable range. The reduction of advertisement costs through performing a search based on a certain geographical range would attract potential sponsors for advertisements and thus enlarge the Internet advertisement market.

Returning to FIG. 5, the temporal storage 580 stores temporally the search result data retrieved by the search result retriever 540 together with the corresponding location range. By storing the previously retrieved search result data with the location range, if the user adjusts the location range, the search result data can be rapidly updated by adding or subtracting a new set of search result to/from the previous search result data, as described below. The temporal storage 580 may also store a distance from a center of the location range to locations related to the search result data, based on which the search result data can be arranged in the order of distance.

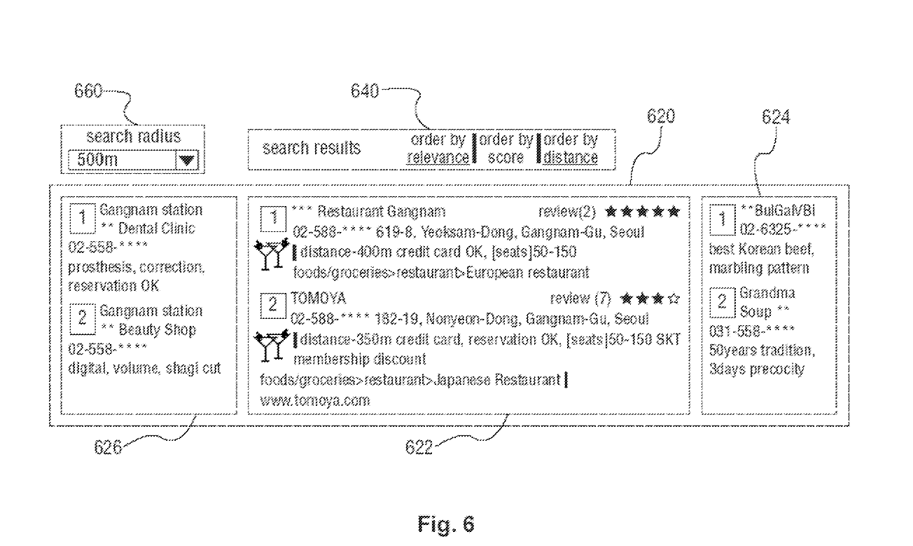

As illustrated in FIG. 2, the search result transmitter 280 receives the search result data from the location search engine 260 and transmits them to a user via the network. FIG. 6 shows an example of a graphic user interface for presenting the search result data to a user. As shown in FIG. 6, the search result data may be displayed in a predetermined order. For example, a display screen includes a part 620 for showing the search result data retrieved by the location search engine 260, a part 640 for showing a menu item for selecting a type of order, in which the search result data are arranged, and a part 660 for showing an input window for inputting a search radius from a user. The part 620 for showing the search result data includes a sub-part 622 for showing search result data retrieved based on both relevant search category and location range, a sub-part 624 for showing a first priority set of search result data which are ranked based on a corresponding search category regardless of the location range, and a sub-part 626 for showing a second priority set of search result data which are ranked based on the location range regardless of the search category.

For example, if a user selects “order by relevance” in the menu 640, the search result data are displayed in the order based on its advertisement costs. On the other hand, if a user selects “order by distance” in the menu 640, the search result data are displayed in the order based on distances between its relevant location to a center of the location range, which is stored in the temporary storage 580.

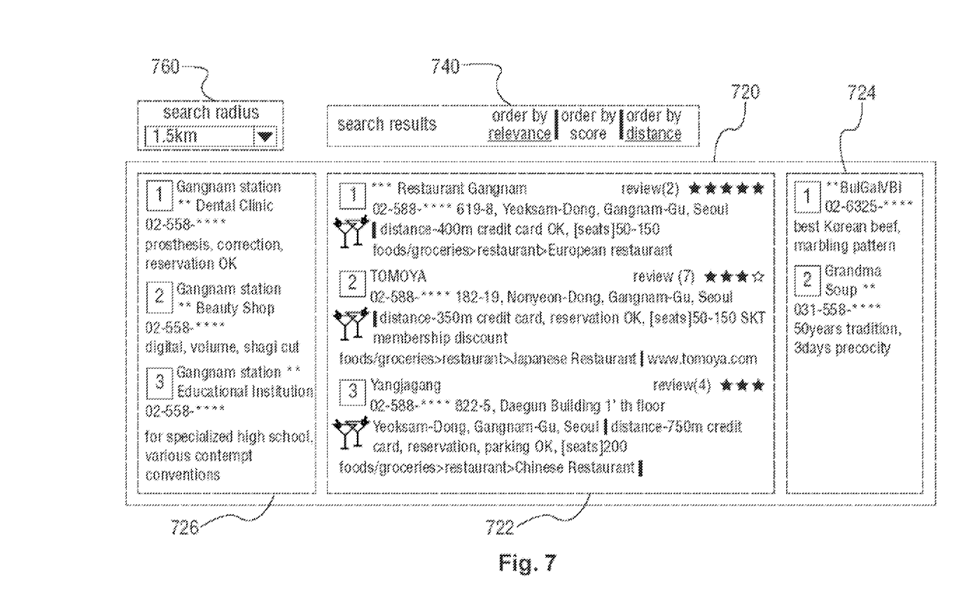

In one embodiment, the apparatus 200 may further include a search radius receiver 230 for receiving a search radius from a user and sending the received search radius to the location search engine 260. The user may input a search radius by using the input window 660. In response to the received search radius, the location range determiner 520 in the location search engine 260 sets the location range to the search radius, and sends the updated location range to the search result retriever 540. Then, the search result retriever 540 retrieves new search result data based on the updated location range. The location range determiner 520 may calculate a location range difference, which is a difference between the updated location range and the previous location range stored in the temporary storage 580. In this case, the search result retriever 540 may retrieve search result data only for the location range difference from the search information database 560 and add the retrieved search result data to the previous search result data stored in the temporary storage 580 to generate updated search result data. Thereafter, the search result retriever 540 transfers the updated search result data to the search result transmitter 280. FIG. 7 shows an example of a graphic user interface for presenting the updated search result data to a user. In FIG. 7, it can be understood that the number of the displayed search results is increased due to an increase of the search radius, e.g., from 500 m to 1.5 km, when compared with the search results shown in FIG. 6.

As described above, the user may input a type or order for displaying search result data by using the menu 640. To implement such a menu, the apparatus 200 includes an order type receiver 250 for receiving a type of order form a user and transferring the received type of order to the location search engine 260, as shown in FIG. 2. The search result retriever 540, in response to the received type order, rearranges the search result data stored in the temporary storage 580 based on the type of order and transfers the rearranged search result data to the search result transmitter 280. For example, if the type of order is set to “order by relevance,” the search result data are ranked based on its advertisement costs paid by sponsors. If the type of order is set to “order by distance,” the search result data are arranged so that the search result data having a closer geographical relation with the center of the location range are ranked higher. If the type of order is set to “order by score,” the search result data are arranged so that the search result data receiving higher evaluation score from users are ranked higher. As shown in FIGS. 6 and 7, the arrangement of the search result data can be different depending on the type of order (“order by relevance” or “order by distance”) inputted by a user.

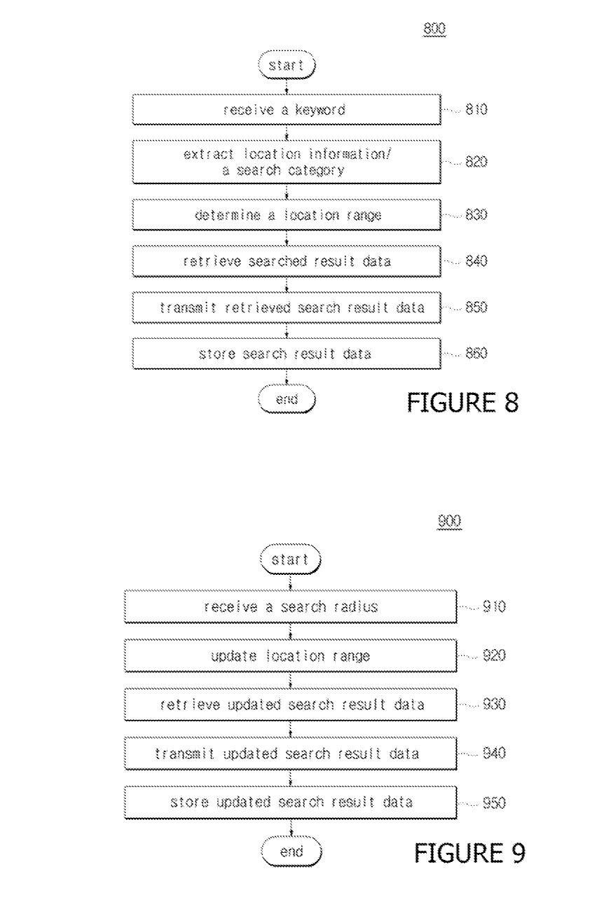

FIG. 8 shows a flow chart of a method for providing regional information based on location in accordance with one embodiment of the present invention. The method 800 may be performed by employing the apparatus 200 for providing regional information based on location, which is described above with reference to FIGS. 1 to 7. Specifically, the keyword receiver 220 of the apparatus 200 receives a keyword from a user connected to the network (step 810). The text search engine 240 extracts location information and a search category from the received keyword (step 820). Then, the location search engine 260 determines a location range based on the extracted location information (step 830), and retrieves search result data from the search information database 560, based on the location range and the search category (step 840). The search result transmitter 280 transmits the retrieved search result data to the user via the network (step 850), while the location search engine 260 stores the search result data in the temporary storage 580 (step 860).

FIG. 9 shows a flow chart of a process for updating search result data in response to a search radius received from a user in accordance with one embodiment of the present invention. The steps illustrated in FIG. 9 may be performed additionally after performing the step 860 of FIG. 8. Particularly, the search radius receiver 230 receives a search radius from a user connected to the network (step 910). Then, the location search engine 260 updates a location range based on the received search radius (step 920), and retrieves updated search result data in the search information database 560 based on the updated location range and the search category (step 930). The search result transmitter 280 transmits the updated search result data to the user via the network (step 940).

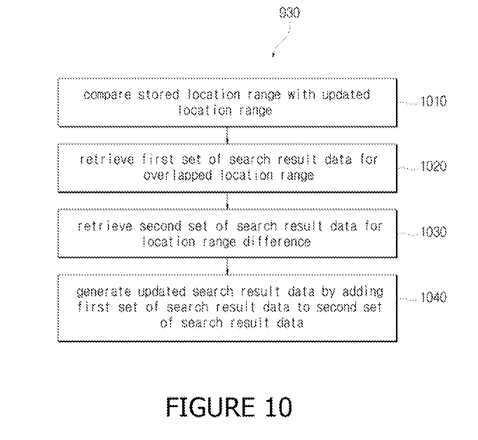

The step 930 of FIG. 9 may further include the steps as described in FIG. 10, which shows a flow chart of a process for retrieving updated search result data. First, the updated location range is compared with the previous location range stored in the temporary storage 580 (step 1010). Then, a first set of search result data are retrieved from the temporal storage 580 for a location range overlapping between the updated location range and the previous location range (step 1020), while a second set of search result data are retrieved from the search information database 560 for a location range corresponding to a difference between the updated location range and the previous location rage (step 1030). In the step 1040, updated search result data are generated by combining the first set of search result data and the second set of search result data.

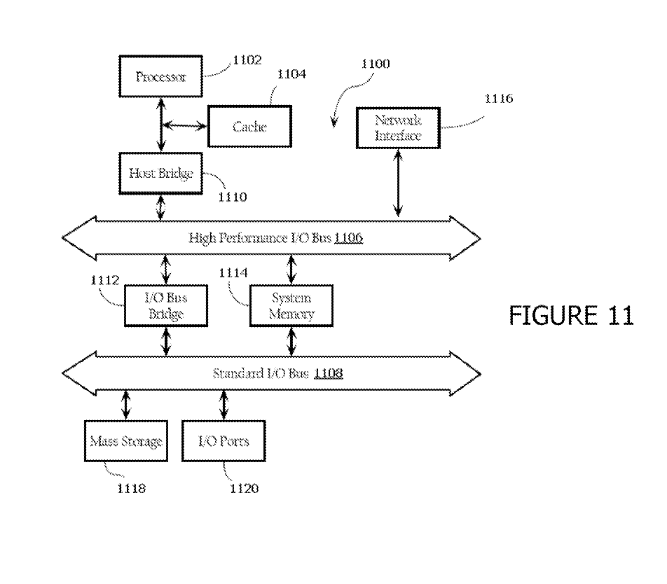

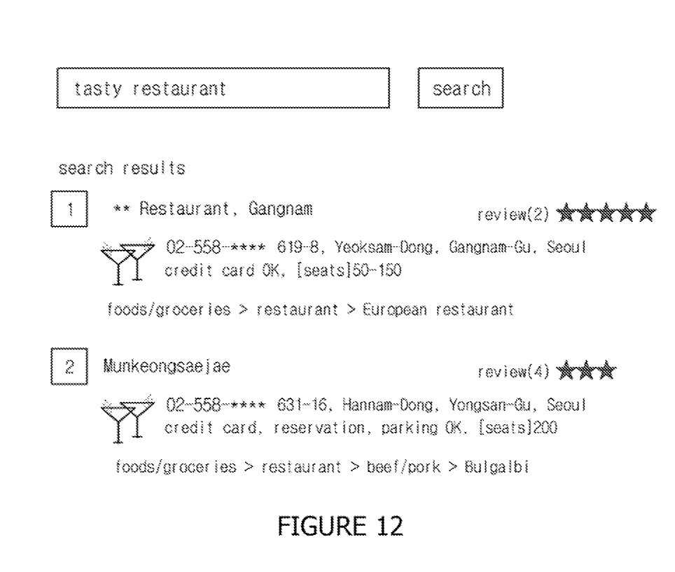

While the methods of the present invention have been described above with reference to specific embodiments, some or all of the elements or operations thereof may be implemented using a computer system having a general purpose hardware architecture. FIG. 11 illustrates an example computing system architecture, which may be used to implement one or more of the operations described herein. In one implementation, hardware system 1100 comprises a processor 1102, a cache memory 1104, and one or more software applications and drivers directed to the functions described herein. Additionally, hardware system 1100 includes a high performance input/output (I/O) bus 1106 and a standard I/O bus 1108. A host bridge 1110 couples processor 1102 to high performance I/O bus 1106, whereas I/O bus bridge 1112 couples the two buses 1106 and 1108 to each other. A system memory 1114 and a network/communication interface 1116 couple to bus 1106. Hardware system 1100 may further include video memory (not shown) and a display device coupled to the video memory. Mass storage 1118 and I/O ports 1120 couple to bus 1108. Hardware system 1100 may optionally include a keyboard and pointing device, and a display device (not shown) coupled to bus 1108. Collectively, these elements are intended to represent a broad category of computer hardware systems, including but not limited to general purpose computer systems based on the Pentium® processor manufactured by Intel Corporation of Santa Clara, Calif., as well as any other suitable processor.

The elements of hardware system 1100 are described in greater detail below. In particular, network interface 1116 provides communication between hardware system 1100 and any of a wide range of networks, such as an Ethernet (e.g., IEEE 802.3) network, etc. Mass storage 1118 provides permanent storage for the data and programming instructions to perform the above described functions implemented in at least a part of the apparatus 180, whereas system memory 1114 (e.g., DRAM) provides temporary storage for the data and programming instructions when executed by processor 1102. I/O ports 1120 are one or more serial and/or parallel communication ports that provide communication between additional peripheral devices, which may be coupled to hardware system 1100.

Hardware system 1100 may include a variety of system architectures, and various components of hardware system 1100 may be rearranged. For example, cache 1104 may be on-chip with processor 1102. Alternatively cache 1104 and processor 1102 may be packed together as a “processor module,” with processor 1102 being referred to as the “processor core.” Furthermore, certain implementations of the present invention may not require nor include all of the above components. For example, the peripheral devices shown coupled to standard I/O bus 1108 may couple to high performance I/O bus 1106. In addition, in some implementations only a single bus may exist, with the components of hardware system 1100 being coupled to the single bus. Furthermore, hardware system 1100 may include additional components, such as additional processors, storage devices, or memories. As discussed below, in one embodiment, the operations of the methods described herein are implemented as a series of software routines run by hardware system 1100. These software routines comprise a plurality or series of instructions to be executed by a processor in a hardware system, such as processor 1102. Initially, the series of instructions are stored on a storage device, such as mass storage 1118. However, the series of instructions can be stored on any suitable storage medium, such as a diskette, CD-ROM, ROM, EEPROM, etc. Furthermore, the series of instructions need not be stored locally, and could be received from a remote storage device, such as a server on a network, via network/communication interface 1116. The instructions are copied from the storage device, such as mass storage 1118, into memory 1114 and then accessed and executed by processor 1102.

An operating system manages and controls the operation of hardware system 1100, including the input and output of data to and from software applications (not shown). The operating system provides an interface between the software applications being executed on the system and the hardware components of the system. According to one embodiment of the present invention, the operating system is the Windows® 95/98/NT/XP operating system, available from Microsoft Corporation of Redmond, Wash. However, the present invention may be used with other suitable operating systems, such as the Apple Macintosh Operating System, available from Apple Computer Inc. of Cupertino, Calif. UNIX operating systems, LINUX operating systems, and the like.

While the present invention and its various functional components have been described in particular embodiments, it should be appreciated that the present invention can be implemented in hardware, software, firmware, middleware or a combination thereof and utilized in systems, subsystems, components or sub-components thereof. When implemented in software, the elements of the present invention are the instructions/code segments to perform the necessary tasks. The program or code segments can be stored in a machine readable medium, such as a processor readable medium or a computer program product, or transmitted by a computer data signal embodied in a carrier wave, or a signal modulated by a carrier, over a transmission medium or communication link. The machine-readable medium or processor-readable medium may include any medium that can store or transfer information in a form readable and executable by a machine (e.g., a processor, a computer, etc.).

The apparatus and method in accordance with the embodiment of the present invention described above provides more customized search results to a user by taking into account both search categories and relevant location information. Further, by employing the apparatus and method of the present invention, sponsors of advertisements would compete for a higher rank in the search results with those who have their stores within a certain geographical range, thereby reducing the costs for advertisements and enhancing the advertisement markets through the Internet search services.

While the present invention has been shown and described with respect to an embodiment, those skilled in the art will recognize that various changes and modifications may be made without departing from the spirit and scope of the invention as defined in the appended claims.

What is claimed is:

1. A method for providing regional information based on location, comprising:
receiving a query including one or more keywords from a user;
extracting location information and a search category from the query;
retrieving search result data based on the search category and a first location range that is determined based on the location information; and
transmitting the search result data to the user.

2. The method of claim 1, further comprising:
receiving a search radius from the user;
determining a second location range based on the location information and the received search radius;
retrieving updated search result data based on the search category and the second location range; and
transmitting the updated search result data to the user.

3. The method of claim 2, further comprising:
storing the search result data and the search category after transmitting the search result data to the user;
wherein the retrieving the updated search result data includes:
comparing the first location range with the second location range;
retrieving a first set of search result data for a location range overlapping between the first location range and the second location range;
if the second location range is larger than the first location range, retrieving a second set of search result data for a difference between the second location range and the first location range, and adding the second set of search result data to the first set of search result data.

4. The method of claim 1, further comprising:
calculating distances from the location indicated by the location information to locations related to the search result data; and
arranging the search result data based on the distances.

5. The method of claim 1, wherein the first location range has a center that is a location indicated by the location information.

6. The method of claim 1, wherein the first location range is adjustable by the user's request.

7. The method of claim 1, further comprising:
receiving a type of order for arranging the search result data from a user; and
arranging the search result data based on the type or order.

8. The method of claim 7, wherein the type of order includes at least one of an ordering by relevant advertisement costs, an ordering by relevant evaluation values and an ordering by distances from the location indicated by the location information.

9. An apparatus for providing regional information based on location, comprising:
a keyword receiver for receiving a keyword from a user;
a text search engine for extracting location information and a search category from the received keyword;
a location search engine for retrieving search result data based on the search category and a first location range that is determined based on the location information; and
a search result data transmitter for transmitting the search result data to the user.

10. The apparatus of claim 9, further comprising:
a search radius receiver for receiving a search radius from the user,
wherein the location search engine determines a second location range based on the location information and the received radius, and retrieves updated search result data based on the search category and the second location range.

11. The apparatus of claim 10, further comprising:
a temporary storage for storing the search category and the search result data,
wherein the location search engine compares the first location range with the second location range, retrieves a first set of search result data for a location range overlapping between the first location range and the second location range, if the second location range is larger than the first location range, retrieves a second set of search result data for a difference between the second location range and the first location range, and adds the second set of search result data to the first set of search result data.

12. The apparatus of claim 9, wherein the location search engine calculates distances from the location indicated by the location information to locations related to the search result data, and arranges the search result data based on the distance.

13. The apparatus of claim 9, wherein the first location range has a center that is a location indicated by the location information.

14. The apparatus of claim 9, wherein the first location range is adjustable by the user's request.

15. The apparatus of claim 9, further comprising:
an order type receiver for receiving a type of order for arranging the search result data form a user,
wherein the location search engine arranges the search result data based on the type of order.

16. The apparatus of claim 15, wherein the type of order includes at least one of an ordering by relevant advertisement costs, an ordering by relevant evaluation values and an ordering by distances from the location indicated by the location information.

17. Logic encoded in one or more tangible media for execution and when executed operable to cause the one or more processors to:
receive a query including one or more keywords from a user;
extract location information and a search category from the query;
retrieve search result data based on the search category and a first location range that is determined based on the location information; and
transmit the search result data to the user.
